(19) United States
(12) Patent Application Publication
(10) Pub. No.: US 2007/0038551 A1
(43) Pub. Date: Feb. 15, 2007

(54) Shari'a compliant trading

(76) Inventor: Mushtaq Shah, London (GB)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 11/407,612

(22) Filed: Apr. 20, 2006

Related U.S. Application Data
(60) Provisional application No. 60/673,007, filed on Apr. 20, 2005.

(51) Int. Cl. G06Q 40/00

(52) U.S. Cl. 705/37

(57) ABSTRACT

Shari'a compliant methods of trading in financial instruments are described. Also described is a system and method for enabling fund managers and brokers to act in a Shari'a compliant manner for Islamic investors. The system includes a database of Shari'a compliant instructions and a compliance and auditing system which determines whether trades are being conducted appropriately and calculates appropriate purification amounts to be paid by the investor.

### CROSS REFERENCE TO RELATED APPLICATION

This application claims benefit of and priority to U.S. provisional application No. 60/673,007 filed on Apr. 20, 2005, the contents of which are hereby incorporated by reference in its entirety.

### FIELD OF THE INVENTION

The present invention relates to methods of conducting business and, in particular, of trading stocks, equities and other instruments in a Shari'a compliant manner. The present invention also relates to systems which ensure that hedge fund managers can operate in a Shari'a compliant manner in order to be able to attract the custom of Islamic institutions.

### BACKGROUND TO THE INVENTION

Shari'a or Islamic law places limitations on the manner in which Islamic institutions or individuals may conduct business. Particular restrictions are that the payment or receipt of interest (Riba) is forbidden and a person may not sell what they do not own. These restrictions cause particular problems for Islamic investors wishing to invest in Western markets where such practices are commonplace. Certain revenue or profit generated by Islamic institutions must also be purified or given to charity under Shari'a law. This practice is not well understood by Western institutions.

One particular investment practice which is popular in Western markets is short selling. Short selling is a strategy for making profits on the decline of an asset price. A short seller initially borrows an instrument from a counter-party that is holding the instrument long. A short seller may to go to a broker who acts as an interface between the counter-party and the short seller. A fee is charged for this service. The short seller then sells the borrowed instrument into the market. To close the short sale, the short seller is obligated to buy the borrowed instrument from the market and return the instrument back to the counter-party, thereby closing the short position.

If the price of the instrument declines between inception and closure of the short sale, a profit is booked for the short seller, since the instrument has been sold at a higher price and bought back later at a lower price to close the trade. However, this strategy exposes the short seller to a potential loss should the instrument rise in price instead. Traditional short selling, as described above, is forbidden by Shari'a law.

Western markets are also open to a wide range of different products and instruments, including stocks based on business activities forbidden by Shari'a law such as those involving alcohol, pornography, pork and so forth.

This lack of a credible asset class with the risk/return profile of high quality corporate bonds or government bonds has meant that Islamic institutions have placed a disproportionate amount of their assets in instruments yielding only cash type returns. There is therefore a need for an alternative to a traditional bond that complies with Shari'a law without significant extra costs or complications. There is also a need for hedge fund managers operating in Western markets to be able to manage their funds in a Shari'a compliant manner at minimal extra cost and without being forced to change key elements of their existing investment processes. For example, Western fund managers should not be forced to understand Islamic concepts such as purification or to take these into account when making trades.

### SUMMARY OF THE INVENTION

Embodiments of the present invention provide an “off the shelf” solution for hedge fund managers which enables them to manage money in a Shari'a compliant manner and to utilise a dynamic Shari'a audit procedure which ensures investor confidence in the product.

In one embodiment of the invention, a system is provided for enabling a fund manager to operate in a Shari'a compliant manner. In particular, the fund manager can operate in a Shari'a compliant manner when conducting trades on behalf of an Islamic investor. The system typically includes an instrument database, an auditing database and a compliance system.

The instrument database stores a list of Shari'a compliant instruments. Such a database will typically be developed and maintained by an agency taking advice from a board of Shari'a experts or scholars. The fund manager has access to the database so that they can ascertain which instruments they may trade on for an Islamic investor.

The auditing database stores a record of instruments traded by the fund manager. Typical funds use sophisticated financial management techniques and turn over portfolios a number of times per year. As a consequence a wide variety financial instruments can be traded and numerous transactions done. Since the portfolio is neither static nor simple, a degree of transparency and a dynamic independent Shari'a audit is required in order to maintain investor confidence and credibility and the auditing database permits this.

The compliance system is in communication with the instrument database and the auditing database and compares trades conducted by the fund manager with the list of Shari'a compliant instruments to determine if any trades have been conducted which are not Shari'a compliant.

In one embodiment, the system also includes an auditing system in communication with the auditing database for determining a proportion of any dividend resulting from trades that requires purification. The resulting audit will typically be passed on to the investor advising them of the appropriate purification amount. This simplifies the process from the perspective of the fund manager who is not required to take the complex issue of purification into consideration when making trades.

Another embodiment of the present invention includes a warning system in communication with the compliance system that warns the fund manager if they perform a trade on an instrument that is not Shari'a compliant. This trade may have been carried out in error by the fund manager or a change in status of the instrument may occur while a hedging trade is in existence. In either case, the fund manager will be advised to take appropriate action such as disposing of or trading out the non-compliant instrument. The auditing system will determine the appropriate action or purification to be taken by the investor as a result of the non-compliant trade, again removing the need for the fund manager to understand this problem.

An alternative embodiment of the present invention provides a method of enabling a fund manager to trade financial instruments on behalf of a investor in a Shari'a compliant manner. The method of this embodiment of the invention will typically be performed by a broker acting as a go-between between the investor and the fund manager. The broker will provide the fund manager with access to a database of Shari'a compliant financial instruments and will send reports to the investor to reassure them that the trading is being done in an Islamic manner. As a consequence, the fund manager can manage his fund in a suitable manner without needing to substantially alter his operating practices. The investor can also be confident that the fund is being managed credibly.

Embodiments of the present invention also provide a method of short selling or hedging in which the short-seller first enters into a Salam agreement with a counterparty to deliver a particular stock to that counterparty within an agreed period of time. The counterparty pays the short-seller the market price of the stock at the time of the agreement minus an agreed fee. The short-seller then buys the stock from the market. If the hedge is successful, the short-seller will be able to buy the stock at a lower price, thereby making a profit. Before expiry of the agreed time period, the short-seller delivers the stock to the counterparty. The short-seller can therefore hedge while still complying with the Shari'a requirement that a person may only sell things that they own. Such a method of hedging will typically be required of fund managers trading on behalf of Islamic investors.

### BRIEF DESCRIPTION OF THE FIGURES

FIG. 1 illustrates a system embodying the present invention.

FIG. 2 illustrates a process for identifying instruments that are Shari'a compliant.

FIG. 3 illustrates a pre-trade process that fund managers must go through.

FIGS. 4a and 4b illustrate a traditional short-selling technique.

FIGS. 5a and 5b illustrate a Salam hedging techniques embodying the present invention.

FIG. 6 illustrates a cash management method.

FIG. 7 illustrates an auditing and compliance process.

FIGS. 8 and 9 illustrate procedures following the discovery of an non-compliant trade.

FIG. 10 illustrates a process for the purification of dividends.

### DETAILED DESCRIPTION

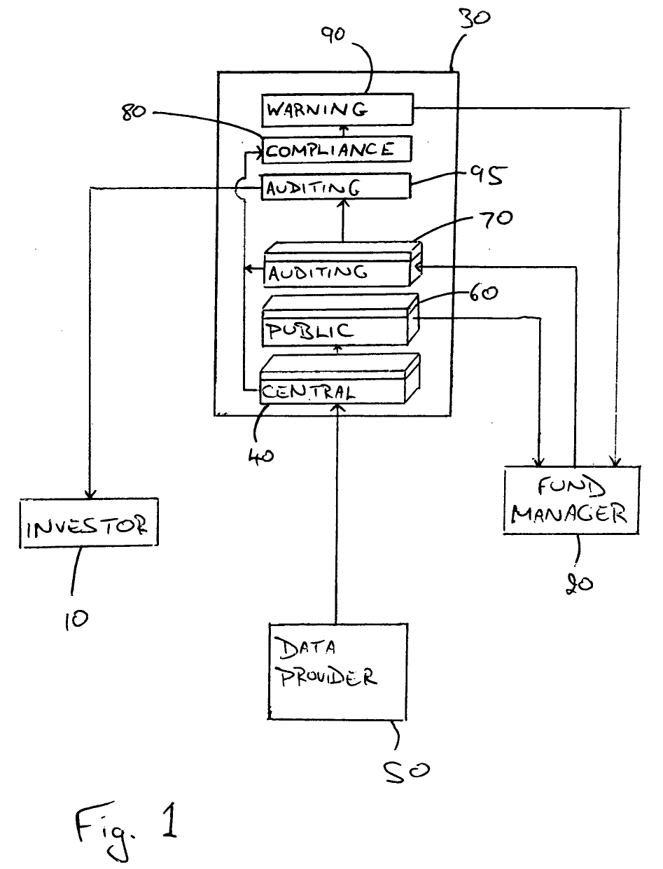

With reference to FIG. 1, an embodiment of the present invention is illustrated. A investor 10 who wishes to invest in a Shari'a compliant manner normally cannot go directly to the majority of investment fund managers 20 or to any brokers who serve them since such people typically do not understand or appreciate Shari'a law. Embodiments of the present invention therefore provide a Shari'a broker 30 who can act as broker between an Islamic investor 10 and any fund manager 20 who agrees to follow a mandate provided to them by the broker 30. In the embodiment shown in FIG. 1, the broker 30 holds all the necessary information and system resources to ensure that trading is conducted in a Shari'a compliant manner. However, it will be recognised that the broker 30 may be a normal broker who is being advised by an administrator which maintains the necessary compliance standards. In this situation, the administrator will manage and maintain the system components indicated as being part of the broker's system in FIG. 1.

The broker 30 (or administrator) maintains a central database 40 (also referred to as a local database, main database or RI database) of financial instruments such as equities, stocks, bonds and so forth that are Shari'a compliant. The process for determining compliance will be described below. Data for determining compliance is received from any suitable data provider or vendor 50. The central database 40 is used to update a public database 60 on a regular basis, typically daily. The fund manager 20 has access to the public database 60. Although the public database 60 is shown as being local to the broker 30, it may also be a remote database which is accessible over a public network such as the Internet using any suitable protocol such as SOAP. The fund manager 20 may alternatively be running a spreadsheet package such as Microsoft Excel which has been adapted to access and download information from the public database 60 to a database maintained by the fund manager 20.

The broker 30 (or administrator) also maintains an auditing database 70 for storing information received from fund managers 20 concerning trades and positions. A compliance component or system 80, which may be an automated computer process, is in communication with the central database 40 and auditing database 70 to determine whether the trades performed by fund managers are Shari'a compliant. A warning component or system 90, which may be an automated computer process, is in communication with the compliance system 80 and informs the fund manager if a non-compliant trade has been made. An auditing system or component 95, which may be an automated computer process, is in communication with the auditing database 70 and prepares compliance reports. Such reports are typically sent to the investor 10.

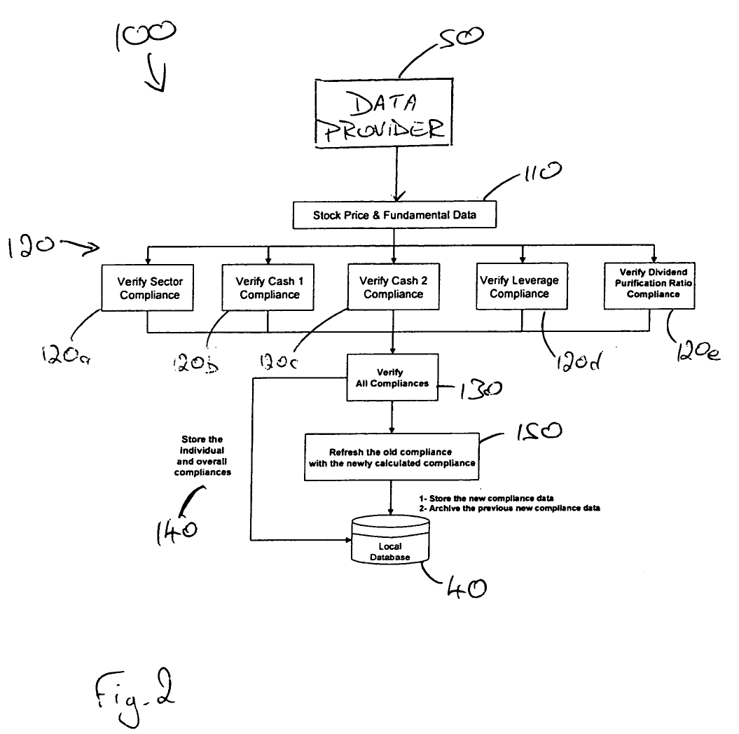

FIG. 2 illustrates a process 100 for identifying instruments that are Shari'a compliant. Stock price and fundamental data 110 is received from data provider 50. The financial instruments, and stocks in particular, are screened 120 using this data on the basis of business activity and accounting ratio. Certain business activities are non permissible from a Shari'a point of view. Whilst nearly all companies will utilise some degree of leverage and earn some income from non-permissible activities, they will still be compliant so long as neither is excessive.

Under sector-based compliance requirements 120a, the following business activities are excluded: Pork, Alcohol, Gambling, Financials, Defense, Advertising and Media (newspapers allowed, sub-sectors analyzed individually), Pornography, Investment management, and Venture capital.

A number of different accounting-based compliance techniques are then applied, in particular techniques based on leverage, cash compliance and dividend purification compliance.

Leverage Compliance 120d is evaluated as: (Debt−Cash)/(Debt+12 month average Market Value of Equity) must be less than 33%.

There are two compliances associated with the Cash Compliance requirement.

Cash Compliance One 120b is evaluated as: Accounts Receivables/(Debt+12 month average Market Value of Equity) must be less than 45%

Cash Compliance Two 120c is evaluated as: Cash/12 month average Market Value of Equity) must be less than 33%.

The Dividend Purification Compliance 120e is evaluated as: Non-Permissible Revenue/Total Revenue must be less than 5%.

For every security the accounting ratios and industry classifications are calculated based on the most recently received data. It is determined whether each security passes or fails the permissible criteria and any changes in status relative to previous data are verified. Once all securities have been verified the refreshed data including the individual and overall compliances is stored 140 in the central database 40. In addition, the refreshed compliance data is stored in the central database 40 and the previous data is archived 150. The public database 60 is updated from the central database 40 at regular intervals, such as daily.

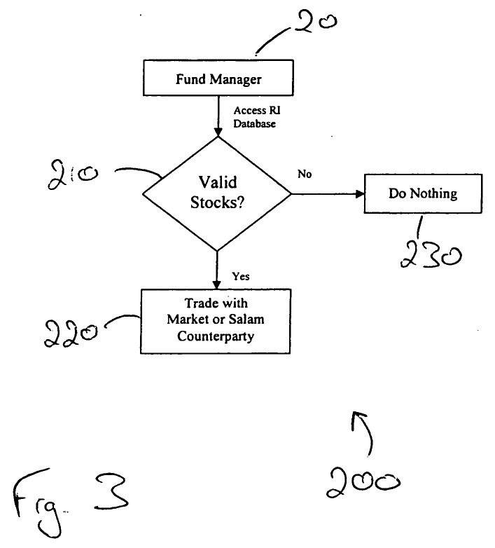

FIG. 3 illustrates a pre-trade process that fund managers must go through. The fund manager 20 queries 210 the public database 60 before carrying out any trades. If the stock is found to be compliant 220, the fund manager 20 goes ahead and trades with his broker or Salam counterparty as will be described in more detail below. However, if the stock is non compliant 230, the fund manager 20 should not trade in this security. The possibility for error on the part of the fund manager does remain, and the process of identifying and correcting such errors post-trade will be described below.

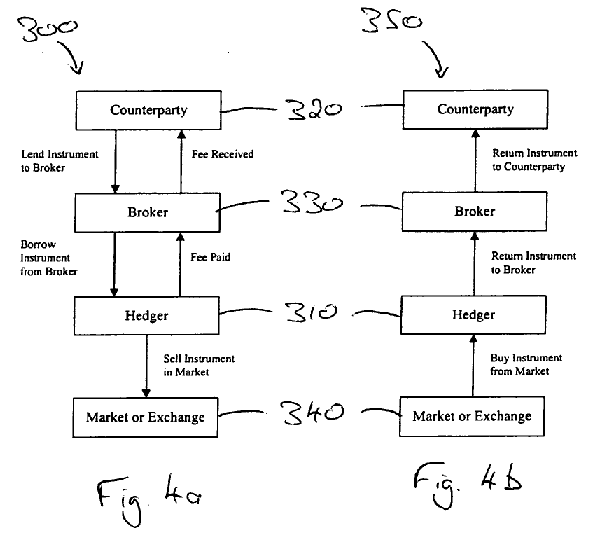

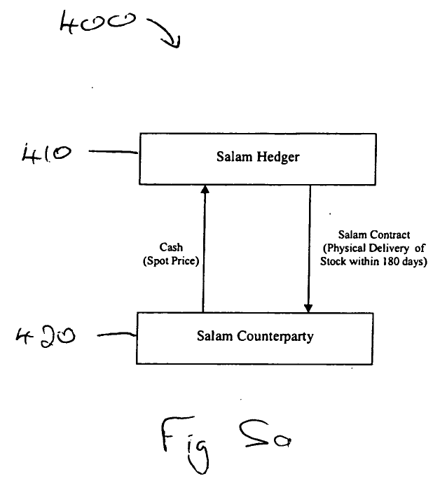

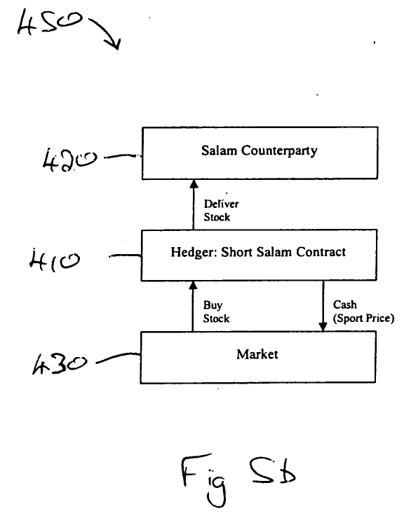

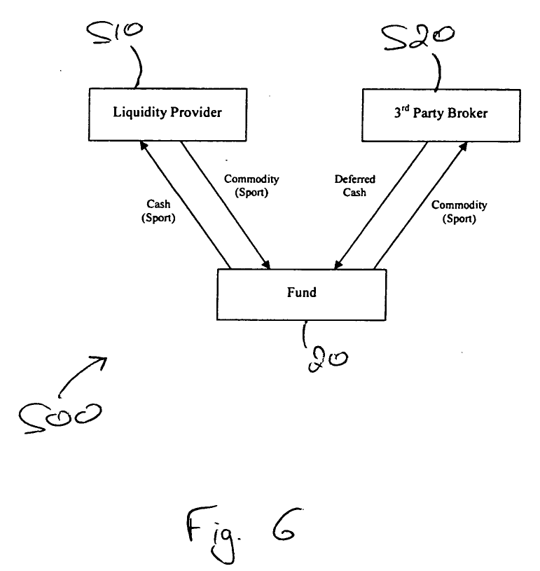

The fund manager 20, when making trades, will be required to conduct those trades in a Shari'a compliant manner. Traditional short-selling, a popular trading technique, is not Shari'a compliant. However, embodiments of the present invention provides a Shari'a compliant method of short-selling or hedging which will be referred to as Salam Hedging. To understand the difference between the two systems, the traditional short-selling method will be described with reference to FIGS. 4a and 4b, and the Salam Hedging process will be described with reference to FIGS. 5a and 5b.

Short selling is the common method by which investors have attempted to take positions in traded instruments that benefit when the price of the instrument goes down. Typically, instruments will be short sold to accomplish one of the following:

(i) Make money from taking a directional view that the price of the instrument is going to fall.

(ii) Create a hedge. Hedging is employed by economic agents to neutralise risks. For instance, a farmer may short sell his/her produce before it is harvested, to neutralise risk that the price of the produce will go down in value when he/she eventually brings the produce to market.

(iii) Arbitrage. An arbitrageur will be taking advantage of price discrepancies in a traded instrument that is fungible in different markets. For instance, the price of wheat may be expensive in the USA and it may be cheap in Europe. An arbitrageur would simultaneously buy wheat from Europe and sell it in the USA, making a risk free profit.

For reasons explained below, traditional short selling to accomplish point (i) above, has never been permitted on an Islamic basis. In addition, short selling for hedging purposes, point (ii) above, has only been permitted if the hedger was the actual producer of the product.

Also, arbitrage, point (iii) above, could only be accomplished by first being in possession of the product before it was sold. For instance, using the example in (iii) above, one would not be allowed to sell the wheat in USA (where it is expensive) on an Islamic basis without first completing the purchase of the wheat in Europe.

Any trade in an instrument has two components: inception, when the trade is initialised and a close, where a previously initialised trade is closed at a profit or loss. A traditional short sale can be broken into two steps.

Step 1, inception of a traditional short sale 300, is illustrated in FIG. 4a. A short seller 310 initially borrows the instrument from a counter-party 320 that is holding the instrument long. A short seller 310 may to go to a broker 330 who acts as an interface between the counter-party 320 holding the instrument long and the short seller 310. A fee is charged for this service. The short seller then sells the borrowed instrument into the market 340.

Step 2, closure of traditional short sale 350, is illustrated in FIG. 4b. To close the short sale, the short seller 310 is obligated to buy the borrowed instrument from the market 340 and return the instrument back to the counter-party 320, thereby closing the short position.

If the price of the instrument declines between inception and closure of the short sale, a profit is booked for the short seller 310, since the instrument has been sold at a higher price and bought back later at a lower price to close the trade. However, this strategy exposes the short seller 310 to a loss should the instrument rise in price instead.

The reason why traditional short selling, as described above, is not permissible from an Islamic point of view is because it is a necessary pre-requisite of Shari'a compliant transactions, for the investor to have ownership of the instrument that is sold. This is not the case for traditional short selling. The investor does not have ownership of the instrument before it is sold. Shari'a is unambiguous in prohibiting traditional short selling.

FIGS. 5a and 5b illustrate a method that overcomes this prohibition by ensuring that the investor wishing to structure an Islamically permissible short sale is in possession of the instrument. FIG. 5a illustrates inception of a Salam Hedging Transaction 400, while

FIG. 5b illustrates closure of a Salam Hedging Transaction 450. The method illustrated will typically be used for the hedging of stocks or equities.

The process involves the use of Salam contracts. Salam contracts have traditionally been used by farmers and other commodity producers to both hedge exposure and ease cash flow issues. The applicant has determined that the use of such contacts for equities is also acceptable. Although complex, Salam contracts are well-known and understood and will not be described in detail in this patent application.

A hedger 410 wants to hedge a stock in a Shari'a compliant manner. The hedger 410 enters into a Salam sale with the Salam counterparty 420 which enables him to hedge the desired stock. A price is agreed and the Salam hedger agrees to deliver the stock an agreed time later (typically, this period of time will be at any time in the next 180 calendar days to ensure Shari'a compliance) and the counterparty 420 pays the spot price for the stock at the time of the agreement minus an agreed fee. The agreed fee is the counterparty's payment for entering into the Salam contract with the hedger 410.

The instrument is delivered to the Salam counterparty 420 at any time in the next 180 days to meet the delivery obligations. This closes the Salam Hedge. In the meantime, the hedger 410 is free to purchase the stock from the market at any time that he considers it most profitable to do so. If the hedge is successful, the market price of the stock will fall and the hedger 410 will be able to buy the stock at a lower price than the spot price at the time of the original agreement.

In addition to the trading of stocks and equities, fund managers typically use cash management techniques to increase the value of a fund. For example, hedge fund mangers may lend and borrow in various currencies in order to respectively generate a return on cash, and to hedge foreign exchange exposure from stock purchases in various non-base currencies. However, these techniques typically centre around the payment or receipt of interest. The payment and receiving of interest (Riba) is forbidden in Islam.

Embodiments of the present invention also provide a method 500 by which cash management techniques may be used in a Shari'a compliant manner, as illustrated in FIG. Cash is managed by commodity based Murahaba transactions in various currencies using only Shari'a approved commodities. Murahaba transactions are well known and will not be described in detail in this patent application.

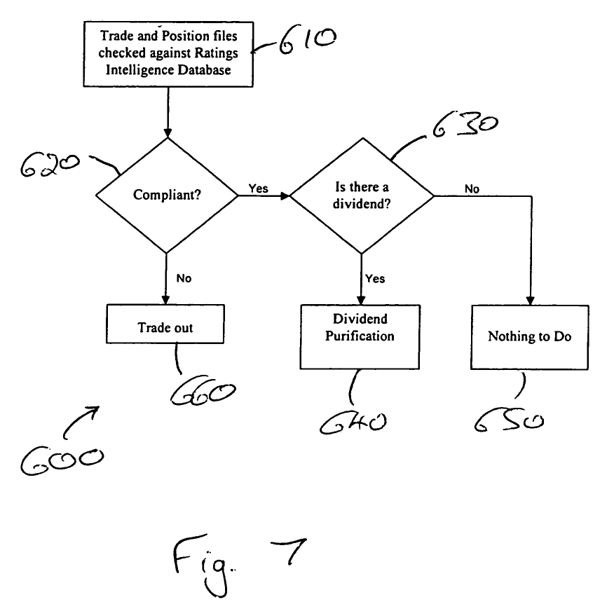

As shown in FIG. 6, the fund manager buys a commodity spot from a liquidity provider 510 with immediate payment. Instantaneously it sells the commodity spot to a third party broker 520, but with deferred payment at a spot price plus a fee. This fee is not interest, but may be based on existing interest rates in order to be appealing to the third party broker 520. For example, the fee is typically based on the London Interbank Offered Rate (LIBOR) less a few basis points. In making such a trade, the fund manager earns a cash equivalent on its funds.

A typical hedge fund uses relatively sophisticated financial management techniques and turns over its portfolio a number of times per year. As a consequence a wide variety financial instruments can be traded and numerous transactions done. Since the portfolio is neither static nor simple, a degree of transparency and a dynamic independent Shari'a audit is required in order to maintain investor confidence and credibility. Embodiments of the present invention privde a Dynamic Compliance/Audit (DCA) tool in order to deal with this issue. This tool utilises technology to ensure that only Shari'a compliant financial products are traded in permissible companies and any errors are quickly corrected. A Compliance Report is completed at regular intervals, typically daily, which is signed off by both an Administrator of the fund and a Shari'a auditor.

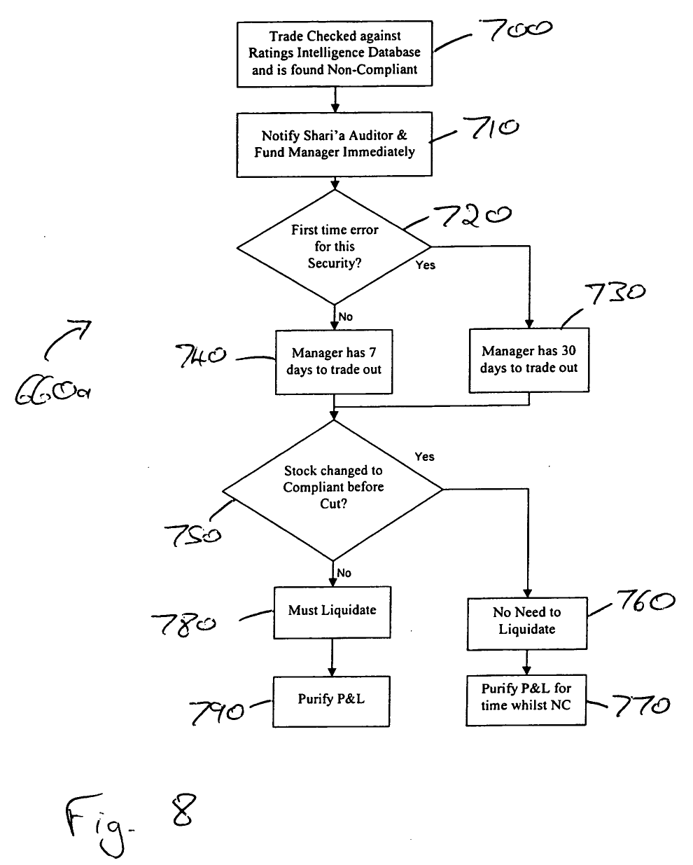

Information about trade made and positions taken by the fund manager 20 are sent to and stored in the auditing database 70 illustrated in FIG. 1. FIG. 7 summarises the processes 600 performed by the DCA using this information. Firstly all reconciled trades and positions are taken. By reconciled is meant that trades and positions are loaded from the auditing database 70 and any breaks corrected. This reconciled data is then compared 610 with the central database 40. This comparison may be performed by the compliance component 80 illustrated in FIG. 1. If the trade/position is compliant then the stock is checked to see if it has gone ex-dividend 630. If so, the dividend will require purification 640. The procedure for the purification of dividends is outlined below. If there is no dividend, then nothing further is required 650.

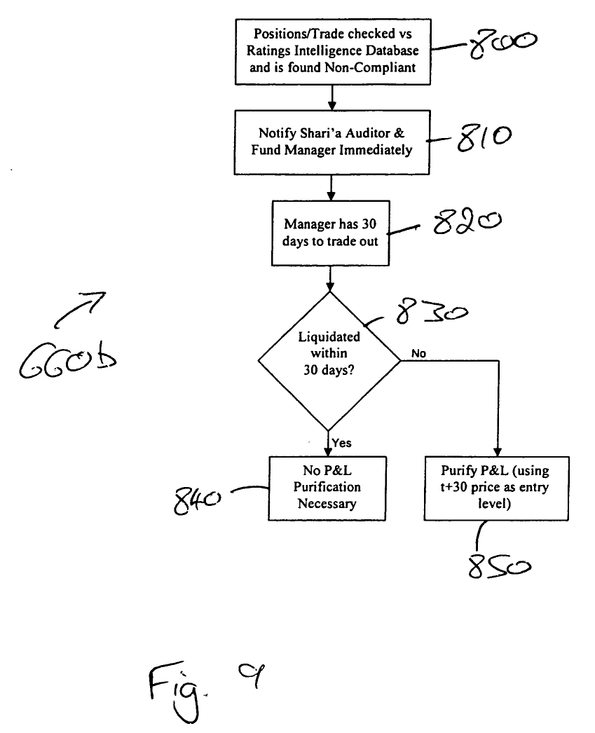

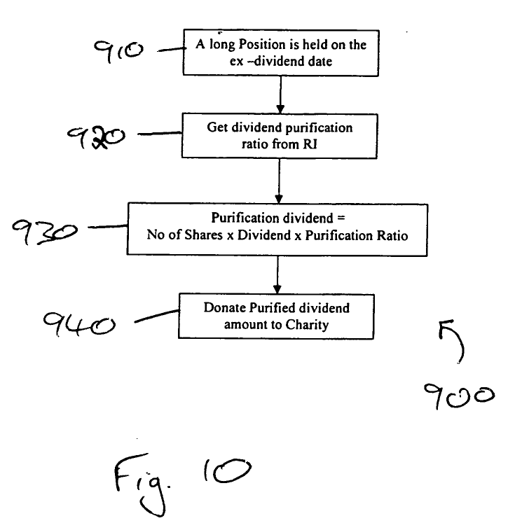

If there is a non-complaint trade or position, then this must be traded out 660. The trading out procedure 600 is illustrated in FIGS. 8 and 9. A distinction is made between stocks that are non-compliant because of an error 660a and those that are existing positions but have become non-compliant because of a status change 660b. A status change occurs either because of a takeover/merger or other corporate action or because of a dramatic change in the share price or changes in the financials.

FIG. 8 illustrates the procedure 660a following the discovery of an non-compliant trade 700 resulting from an error. Both the fund manager 20 and the Shari'a auditor are informed immediately 710. This may be done by the warning component 90 illustrated in FIG. 1.

It is then determined whether this is the first error in this particular security 720. If this is the first error, then the fund manager 30 is given a period of time such as thirty trading days to close the position 730. However, if it is an error in a stock where there has been a mistake previously, then the fund manager is given a shorter period of time, such as seven trading days to close the position 740.

If the status of the position subsequently becomes compliant before being liquidated 750, then there is no need to liquidate the position 760. However the profit generated during the time whilst the stock was non-compliant must be purified (i.e. donated to charity) 770. If the stock remains non-compliant then it mist be liquidated 780 and any profits generated from this non-compliant transaction must be purified 790.

FIG. 9 illustrates the procedure 660b following the discovery of an non-compliant trade 700 resulting from a status change of the instrument in question. Both the fund manager 20 and the Shari'a auditor are informed immediately 810. This may be done by the warning component 90 illustrated in FIG. 1.

The fund manager is informed that he has a period of time such as thirty trading days to close the position 820. It is subsequently determined whether the fund manager 20 did liquidate the position within the time period provided 830. If the position was liquidated in time, then no purification of profits is necessary 840. However, if the position is not liquidated in time, than any profits generated relative to the price level of the stock at the end of the period provided must be purified 850.

During trading, profits may be made on the basis of dividends. FIG. 10 illustrate a process 900 for the purification of such dividends. The reason for this purification is that of a dividend will have been earned through non Shari'a permissible activities such as interest received. This part needs to be given away to charity. The auditing system 95 illustrated in FIG. 1, or the administrator is responsible for this calculation.

All long positions are taken on the ex-dividend date 910 (i.e. the date that the stock was traded without the dividend). If the stock is compliant on that day then the central database is queried and a purification factor is returned 920. The purification factor is calculated as: revenue from non permissible activities/total revenue. The factor is multiplied by the dividend times the number of shares held to work out the dollar amount that needs to be purified 930. This amount is then provided to the investor 10 in a report, preferably a monthly valuation report. The report may be sent automatically by email. The investor is then responsible to donate that amount to a charity of his choice 940.

Preferred embodiments of the present invention have been described by way of an example only. A person of normal skill in the art will recognise that changes may be made to these embodiments without departing from the spirit or scope of the invention. The invention is rather defined by the scope of the appended claims, including all equivalents.

1. A system for enabling a fund manager to operate in a Shari'a compliant manner, comprising:
an instrument database comprising a record of Shari'a compliant instruments;
an auditing database for receiving an identification of instruments traded by the fund manager; and
a compliance system in communication with the instrument database and the auditing database for identifying trades that have been conducted on instruments that are not Shari'a compliant.

2. The system of claim 1 wherein the auditing database is further for receiving an identification of an amount of dividend on instruments traded by the fund manager, the system further comprising:
an auditing system in communication with the auditing database for determining a proportion of the dividend requiring purification.

3. The system of claim 1 further comprising:
a warning system in communication with the compliance system for informing a fund manager if a trade has been conducted on an instrument that is not Shari'a compliant.

4. The system of claim 3 wherein the warning system is adapted to advise the fund manager to dispose of the instrument within a first time period.

5. The system of claim 4 wherein the warning system is adapted to advise the fund manager to dispose of the instrument within a second time period, shorter than the first time period, if the fund manager has previously been informed that the instrument is not Shari'a compliant.

6. The system of claim 3 further comprising an archive database comprising an archive of instruments that have been Shari'a compliant in the past; and wherein
the compliance system is in communication with the archive database and is adapted to identify a trade on an instrument that was initiated at a time when the instrument was Shari'a compliant but for which the trade is ongoing at a time when the status of the instrument has changed such that the instrument is no longer Shari'a compliant; and
the warning system is adapted to inform the fund manager of the change of status of the instrument and to advise the fund manager to dispose of the instrument within a predetermined time period.

7. The system of claim 6 wherein the auditing system is further adapted to determine a purification amount in respect of profits generated by the instrument if the fund manager does not dispose of the instrument within the predetermined time period.

8. A method of enabling a fund manager to trade financial instruments on behalf of a investor in a Shari'a compliant manner, comprising:
maintaining a database of financial instruments that are Shari'a compliant;
providing the fund manager with access to the database;
monitoring trades performed by the fund manager and informing the fund manager if the find manager trades an instrument that is not Shari'a compliant;
providing the investor with a report of trades performed by the fund manager, the report including an amount of money requiring purification as a consequence of the trades.

9. The method of claim 8 further comprising:
requiring the fund manager to trade in a Shari'a compliant manner.

10. A method of hedging comprising:
agreeing to deliver a stock to a party within an agreed period of time from a time of the agreement;
receiving payment from the party for the stock;
subsequently purchasing the stock from a market;
delivering the stock to the party within the agreed period of time.

11. The method of claim 10 wherein the agreement is a Salam contract.

12. The method of claim 10 wherein the payment is equal to the spot rate for the stock at the time of the agreement minus an agreed fee.

13. The method of claim 10 wherein the stock is purchased from the market at the market rate at a time of the purchase.

14. The method of claim 10 wherein the agreed period of time is 180 days.

15. The method of claim 10 wherein the method is Shari'a compliant.
